(19) United States
(12) Patent Application Publication
(10) Pub. No.: US 2011/0085874 A1
(43) Pub. Date: Apr. 14, 2011

(54) ATTACHMENT DEVICE FOR PLASTER WALLS

(76) Inventor: Zvi Davidowitch, Tel Aviv (IL)

(21) Appl. No.: 12/293,706

(22) PCT Filed: Mar. 22, 2006
(86) PCT No.: PCT/IL07/00303

§ 371 Date: Nov. 8, 2010

(30) Foreign Application Priority Data
Mar. 22, 2006 (IL) 174485

(51) Int. Cl. F16B 13/00

(52) U.S. Cl. 411/82.1

(57) ABSTRACT

An attachment device for plaster walls (w) comprising a flat base member (12) with a series of throughgoing openings (14a, 14b, 14c; 14d) each forming an acute angle (α) with respect to a plane perpendicular to that of the base member, nails being driven into the wall through each of the openings.

### FIELD OF THE INVENTION

The present invention concerns attachment means for suspending objects on plaster (gypsum) walls.

### BACKGROUND OF THE INVENTION

Mostly if not exclusively there are used plastic wall plugs for, e.g., hanging pictures or the like on plaster walls. The procedure involves drilling or pronging a hole in the wall for inserting thereinto the wall-plug. The plug contains bifurcated legs which jump away from each other behind the wall and retain this spreaded position when a screw is inserted and cuts its thread in the plastic material of the plug.

Several disadvantages of this method have been recognized, amongst which are that unskilled persons find it difficult to practice; the need for tools; generation of dust and dirt; the plugs tend to loose their grip after prolonged use; and the limited amount of load that these plugs can sustain.

The prime object of this invention is to overcome these disadvantages by providing a plaster walls mounting article of simple construction which is easily attached to the wall and adapted to bear loads considerably greater than the conventional wall-plugs.

### SUMMARY OF THE INVENTION

Thus provided according to the invention is an attachment device for plaster walls comprising a flat base member with a series of throughgoing openings each forming an acute angle with respect to a plane perpendicular to that of the base member, nails being driven into the wall through each of the openings.

Preferably, the axises of all openings converge at a point distanced from one side of the base member and in register with the geometrical center of the base member.

According to a preferred embodiment of the invention the nails are produced in groups by plastic injection integrally with lengths of wire connecting nails heads of the group to each other.

The exposed side of the base member may be provided with means for holding objects to be suspended from the device such as a hook-shaped projection, a female screw-threaded insert embedded in the material of the base member, dove-tail ribs, and others.

### BRIEF DESCRIPTION OF THE DRAWINGS

These and additional constructional features and advantages of the invention will be more readily understood in the light of the ensuing description of several preferred embodiments thereof, given by way of example only, with reference to the accompanying drawings wherein:—

FIG. 1 is a perspective exploded view of an attachment device designed according to the principles of the present invention;

FIG. 2 is a cross-section taken along line II-II of FIG. 1;

FIG. 3 illustrates an intermediate stage of mounting the attachment device of FIG. 1 to a wall;

FIG. 4 is the final stage;

FIG. 5 is an elevation of FIG. 4;

FIG. 6 shows a group of four nails fabricated by plastic injection process integrally with connecting wires;

FIG. 7 is an elevation of FIG. 6;

FIGS. 8a-8c illustrate stages of intergrading a set of nails with the base member in a readily marketable form;

FIG. 9 is a cross-sectional view of the device for use with a suspension bolt;

FIG. 10a is a cross-sectional view of the device with dove-tail male ribs;

FIG. 10b is plan view of the device of FIG. 10a;

FIG. 11a is a plan view of a modified embodiment of an attachment device of the present invention; and

FIG. 11b is cross-section taken along line XI-XI of FIG. 11a.

### DETAILED DESCRIPTION OF THE PREFERRED EMBODIMENT

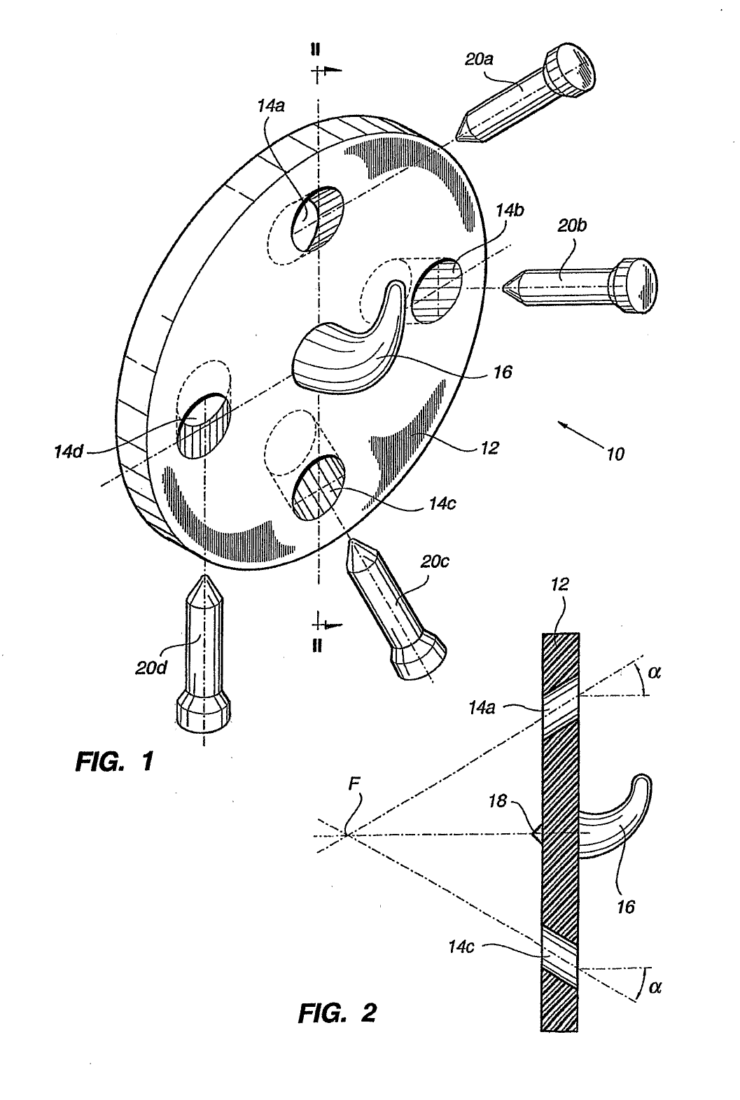

As shown in FIG. 1, the plaster wall attachment device generally designated 10 comprises a base member 12 being in the described example a circular plate of typically 50ₘₘ in diameter and 5ₘₘ thick. Obviously other shapes and measurements can be applied to satisfy specific requirements.

The base member 12 is formed with four throughgoing openings 14a-14d, each inclined by an acute angle α relative to a plane perpendicular to the surface of the base 12. Furthermore, the axial directions of all openings converge towards a common focal point F lying beyond the base on the central axis thereof as seen in FIG. 2.

The base member 12 is further provided with a hook-shaped protrusion 16 at one side for hanging a picture or the like; and preferably with a centrally located sting 18 at the opposite side.

A series of nail 20a-20d are used, of diameters slightly less than the diameter of the openings 14. Preferably, for a purpose to be described further below, the nails a slightly widened at the top (heads) so as to become press-fitted into the openings 14 at the end of the driving stage.

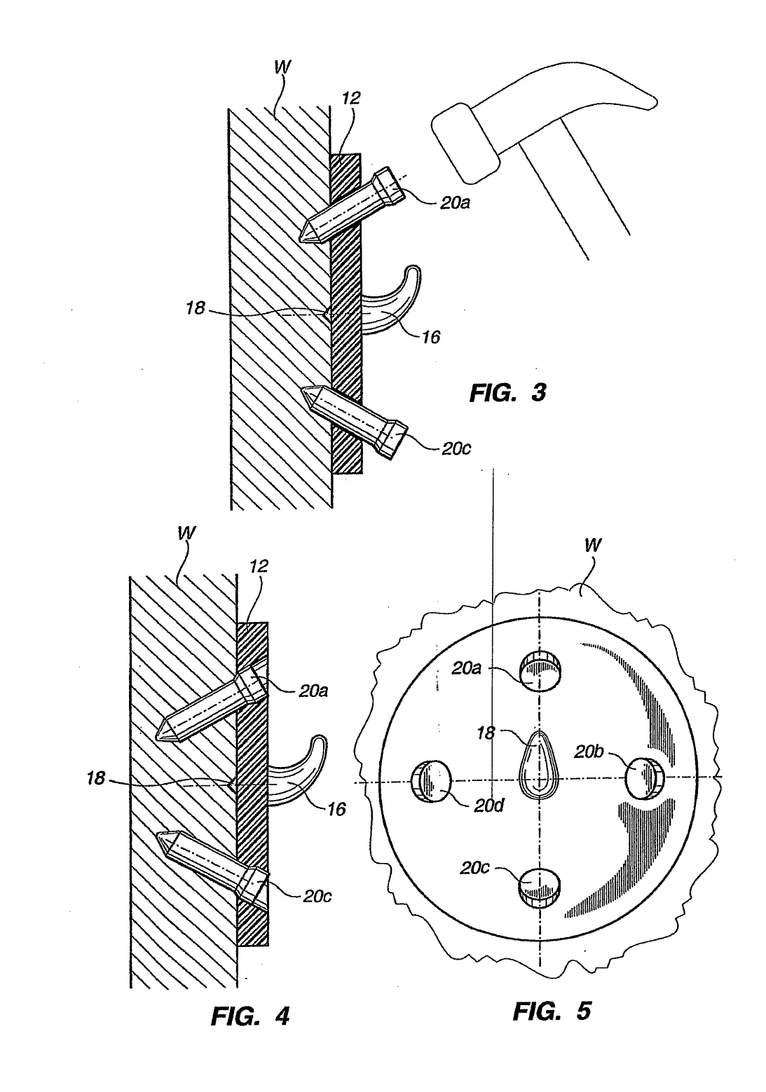

The mounting of the attachment device 10 to a plaster wall W is illustrated in FIGS. 3-5.

At first, the base member 12 is placed at the desired location and pressed against the wall W. This is where sting 18 becomes instrumental to avoid slippage, bearing in mind that the plaster wall W is relatively soft.

Then, the nails 20 are placed in their respective openings and progressively hammered into the wall until fully hidden, namely that the heads becomes flush with the outer exposed surface of the base member 12 as shown in FIG. 4.

Because of the oblique direction of the nails relative to the plane of the wall W, a firm grip of the base-member 12 is achieved. The greater the number of the nails—the stronger the attachment.

For facilitating the mass production of the attachment device in a readily marketable article form, it is proposed, according to an additional aspect of the present invention, to produce the set of nails by plastic injection process, e.g. of Nylon reinforced by glass-fibers a known per-se in the relevant art (30% of the fibers is recommended).

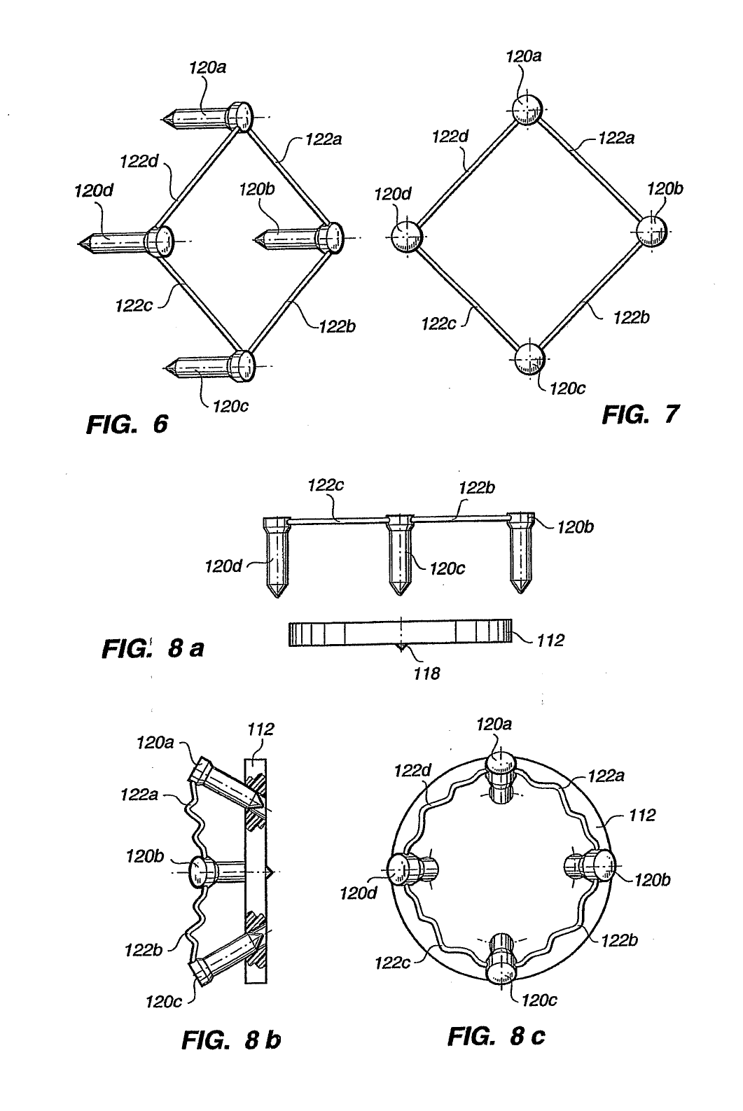

Hence, in FIGS. 6 and 7 there is shown a set of four nails 120a-120d produced in a plastic mold. Preferably, there are integrated in the molding process four pieces of wire 122a-122d connecting the heads of the nails 120a-120d, respectively.

The base member 112 is produced separately as already described.

The objective is to efficiently mass-produce assemblies of the base member with the nails seated or partly penetrating their respective openings. So, rather than attending to the individual insertion of every nail manually (even by cheap labor), the above described improvement, namely dealing with the nails interconnected in groups by the wires 122, allows the application of automation (robotics) to complete the assembly in a ready-for-sale state as depicted in FIGS. 8b and 8c. (The technical details of the automated process falls beyond the scope of this application).

The design of the base member can take many forms, depending on the designed function of the attachment device.

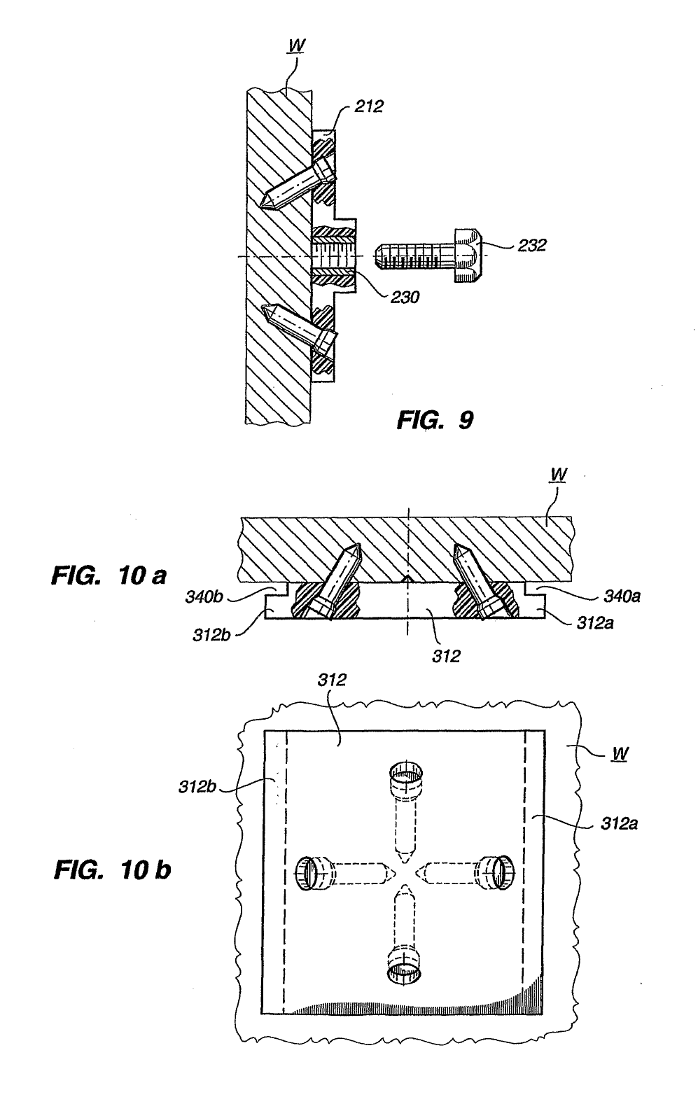

In FIG. 9, the base member 212 contains an embedded insert 230 with female screw thread, for receiving bolt 232.

In FIGS. 10a and 10b, the base member 312 is square, containing a pair of opposite, vertically extending ribs 312 and 312b.

The article which is desired to be suspended on the wall W (e.g. a coats hanging bracket—not shown) will be provided with counter ribs fitting the gaps 340a and 340b between the ribs 312a and 312b and the surface of the wall W, respectively, and will become suspended by sliding from above.

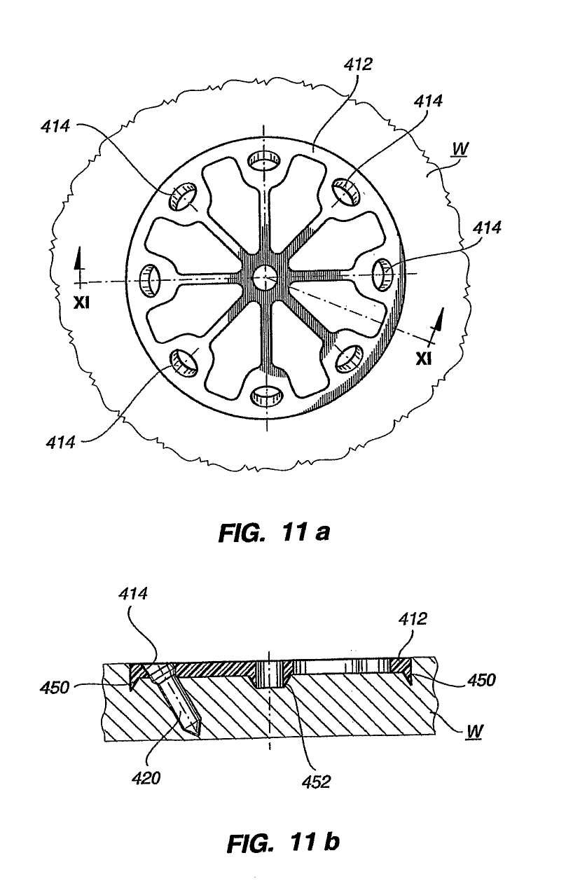

According to the modified embodiment shown in FIGS. 11a and 11b, the base member 412 is formed, in addition to the plurality of oblique holes 414, with: (1) a circumferential knife-edge rib 450; and (2) a central knife-edge cup-shaped projection 452. This will allow the base member 412 to be initially hammered into the surface of the relatively soft material of the plaster wall for extra durability of the attachment.

Those skilled in the art to which this invention pertains will readily appreciate that numerous changes, variations and modifications can be effectuated without departing from the true spirit and scope of the invention as defined in and by the appended claims.

What is claimed is:

1. An attachment device for plaster walls comprising a flat base member with a series of throughgoing openings each forming an acute angle with respect to a plane perpendicular to that of the base member, nails being driven into the wall through each of the openings.

2. The device as claimed in claim 1 wherein the axises of all openings converge at a point distanced from one side of the base member.

3. The device as claimed in claim 2 wherein said point is in register with the geometrical center of the base member.

4. The device as claimed in claim 3 wherein the diameter of the nails is slightly less than the diameter of the openings.

5. The device as claimed in claim 4 wherein the diameter of nails is increased towards the head portion thereof.

6. The device as claimed in claim 5 wherein the nails are made of a resinous material.

7. The device as claimed in claim 6 wherein the resinous material is Nylon reinforced by glass fibers.

8. The device as claimed in claim 7 wherein the nails are produced by injection.

9. The device as claimed in claim 8 wherein groups of two or more nails are produced integrally with lengths of wire connecting nail heads of the group to each other in series.

10. The device as claimed in claim 1 wherein the base member is made of a resinous material.

11. The device as claimed in claim 10 wherein one or more stings are formed at the surface of the base member adapted to be pressed into the wall.

12. The device as claimed in claim 10 wherein the base member is formed with a circumferential knife-edge rib adapted to be pressed into the wall.

13. The device as claimed in claim 12 wherein the base member is formed with a central, cup-shaped projection with knife-edge rim adapted to be pressed into the wall.

14. The device as claimed in claim 1 wherein the exposed side of the base member is provided with means for holding objects to be suspended from the device.

15. The device as claimed in claim 14 wherein said means comprise a hook-shaped projection.

16. The device as claimed in claim 14 wherein said means comprise a female screw-threaded insert embedded in the material of the base member.

17. The device as claimed in claim 14 wherein said means comprise ribs extending at opposite sides of the base member.
